(19) United States
(12) Patent Application Publication
(10) Pub. No.: US 2023/0071479 A1
(43) Pub. Date: Mar. 9, 2023

(54) OPTICAL LENS DEVICE HAVING A POLARIZATION MINIATURE STRUCTURE AND METHOD THEREOF

(71) Applicant: FORESIGHT OPTICAL LTD., Tainan (TW)

(72) Inventors: YUE-CHANG TSAI, Tainan (TW); TIEN-SHU WU, Tainan (TW); YEN-TING WU, Tainan (TW); LAI-CHUN CHOU, Tainan (TW); SHUN-YEN CHENG, Tainan (TW)

(21) Appl. No.: 17/903,800

(22) Filed: Sep. 6, 2022

Related U.S. Application Data
(63) Continuation-in-part of application No. 17/828,855, filed on May 31, 2022.

(30) Foreign Application Priority Data
Sep. 8, 2021 (TW) 110133447

(51) Int. Cl. B29D 11/00

(52) U.S. Cl. CPC B29D 11/00644; B29D 11/00009

(57) ABSTRACT

An optical lens device includes an optical substrate layer, an optical thin film, an optical polarization layer and a miniature surface structure. The optical substrate layer has a first surface and a second surface and rays of light passes through the optical substrate layer. The optical polarization layer is provided on a surface of the optical thin film. The miniature surface structure is physically processed to form the optical polarization layer and provides a characteristic of optical polarization in the optical polarization layer. The miniature surface structure of the optical thin film provides an optical polarization effect to the rays of light while passing through it.

### CROSS REFERENCE TO RELATED APPLICATIONS

This application is a continuation-in-part of U.S. patent application Ser. No. 17/828,855, filed May 31, 2022, which is hereby incorporated by reference in its entirety.

### BACKGROUND OF THE INVENTION

### 1. Field of the Invention

The present invention relates to an optical lens device having a polarization miniature structure layer and method thereof. Particularly, the present invention relates to the optical lens device having a surface polarization microstructure layer and method thereof. More particularly, the present invention relates to the optical lens device having a polarization miniature pattern structure layer or microstructure layer and operation or manufacturing method thereof.

### 2. Description of the Related Art

Taiwanese Patent Publication No. TW-556286, entitled “Manufacturing method of micro lens,” discloses a manufacturing method of producing micro lens for an optical device comprises: coating a thermoplastic organic material layer on a flat substrate or adhering the thermoplastic organic material layer to the flat substrate.

The manufacturing method of producing micro lens for an optical device further comprises: in a laser etching operation, using a laser beam to directly remove some unwanted portions from the thermoplastic organic material layer by vaporization and to thereby remain a desire pellet-like pattern formed thereon.

The manufacturing method of micro lens for producing an optical device further comprises: in softening operation, heat-treating the remained pellet-like pattern of the thermoplastic organic material layer formed on the flat substrate, thereby forming a spherical surface or a cambered surface on a surface of the thermoplastic organic material layer.

The manufacturing method of producing micro lens for an optical device further comprises: in plating operation, plating a conductive metal thin layer on the surface of the thermoplastic organic material layer which is further provided to form an injection mold mechanism, with cooperating with an injection molding machine, in an injection operation, to produce a substrate panel which is formed with a micro lens.

However, the above-mentioned injection mold mechanism and the manufacturing method thereof or the above substrate panel with the micro lens produced thereby cannot be possibly performed as an optical polarization mechanism of lens devices or further successfully modified to provide an optical polarization mechanism of lens devices.

Further, Taiwanese Patent Application Publication No. TW-201041712, entitled “Mold core, mold apparatus and method for press-molding micro concave lens array,” discloses a mold core for a press-molding micro concave lens array. The mold core has an end surface on which a plurality of spacers is formed.

Each of spacers has a top surface which is formed in an identical level with the end surface of the mold core. Each of spacers further defines a mold cavity therein and can be utilized to form a micro concave lens in press-molding operation.

A convex surface is formed in an inner space of the mold cavity for press-molding operation and is also protruded upward from a bottom surface of the mold cavity. The convex surface also has a highest point which is lower than a top surface of the mold cavity.

However, the above-mentioned mold core, mold apparatus thereof and manufacturing method thereof for the press-molding micro concave lens array cannot be possibly performed as an optical polarization mechanism of lens devices or further successfully modified to provide an optical polarization mechanism of lens devices.

Further, Taiwanese Patent Publication No. TW-I709761, entitled “Optical lens having a laser-induced periodical microstructure,” discloses an optical lens having a laser-induced periodical microstructure. The optical lens having the laser-induced periodical microstructure is formed from an optical lens device.

The optical lens is selected from a single-piece member, with the optical lens having a flat surface and a curved surface provided on opposite surfaces thereof. The curved surface of the optical lens is induced by a laser to form a laser-induced periodical surface microstructure.

The laser-induced periodical surface microstructure has a microstructure arrangement and a microstructure size, with the microstructure arrangement formed from a plurality of structure members which are in a periodical arrangement, with the microstructure size formed from a spaced width ranging between 50 nm and 1000 nm, with the microstructure size formed from a height ranging between 50 nm and 500 nm.

However, the above-mentioned laser-induced periodical surface microstructure of the optical lens is not an optical grating structure for polarization such that it cannot be possibly performed as an optical polarization mechanism of lens devices or further successfully modified to provide an optical polarization mechanism of lens devices.

Further, Taiwanese Patent Publication No. TW-I611217, entitled “Lens having microstructures,” discloses a lens device having microstructures. The lens device having microstructures has a first surface and a second surface, with the first surface having a central portion thereof.

Provided at the central portion of the first surface is an optical portion which has an optical mechanism portion. Defined around the optical portion is the optical mechanism portion. At least one part of optical mechanism portion is formed with at least one recessed microstructure which has a bottom surface. The bottom surface is a rough surface formed by laser processing.

However, the above-mentioned recessed microstructure of the lens is not an optical grating structure for polarization such that it cannot be possibly performed as an optical polarization mechanism of lens devices or further successfully modified to provide an optical polarization mechanism of lens devices.

Further, Taiwanese Patent Publication No. TW-M519748, entitled “Lens having microstructures,” discloses a lens device having microstructures. The lens device having microstructures has a first surface and a second surface, with the first surface having a central portion thereof.

Provided at the central portion of the first surface is an optical portion which has an optical mechanism portion. Defined around the optical portion is the optical mechanism portion. At least one part of optical mechanism portion is formed with at least one recessed microstructure which has a bottom surface. The bottom surface is a rough surface formed by laser processing.

The lens device having microstructures defines a longitudinal axis which passes through a center of the lens device. The microstructures is selected from a plurality of annular grooves, a plurality of grooves or a spiral groove. The plurality of annular grooves surround the longitudinal axis and extend along the longitudinal axis. The plurality of annular grooves are concentric annular grooves which are spaced apart among them. The plurality of grooves also surrounds the longitudinal axis and also extend along the longitudinal axis. The spiral groove also extends along the longitudinal axis to form a spiral structure.

However, the above-mentioned recessed microstructure of the lens is not an optical grating structure for polarization such that it cannot be possibly performed as an optical polarization mechanism of lens devices or further successfully modified to provide an optical polarization mechanism of lens devices.

Further, Taiwanese Patent Application Publication No. TW-201719241, entitled “Eyeglasses having a microstructure of an optical structure,” discloses an eyeglasses having a microstructure of an optical structure which comprises a basic lens and a corrective lens.

The basic lens and the corrective lens are combined to form a single piece member which is formed as a single-piece shape lens. The basic lens has a microstructure which includes a plurality of predetermined notches or a concave and convex curved surface. The plurality of predetermined notches are concentric notches and the microstructure of the concave and convex curved surface has various angles.

However, the above-mentioned microstructure of the eyeglasses is not an optical grating structure for polarization such that it cannot be possibly performed as an optical polarization mechanism of lens devices or further successfully modified to provide an optical polarization mechanism of lens devices.

However, there is a need of improving the conventional lens devices for providing an optical grating structure performed as an optical polarization mechanism of lens device. The above-mentioned patents and patent application publications are incorporated herein by reference for purposes including, but not limited to, indicating the background of the present invention and illustrating the situation of the art.

### SUMMARY OF THE INVENTION

The primary objective of this invention is to provide an optical lens device having a polarization miniature structure and method thereof. A first surface and a second surface are provided on an optical substrate, with the first surface or the second surface combing with an optical thin film, with forming at least one miniature surface structure on a surface of the optical thin film to form an optical polarization layer, with a light ray or a light beam passing through the miniature surface structure of the optical thin film to generate an optical polarization effect. Advantageously, the optical lens device of the present invention is successful in providing an optical grating structure for polarization, reducing a total thickness of lens device, and further increasing eye comfortability and eye protection.

The optical lens device in accordance with an aspect of the present invention includes:

an optical substrate having a first surface and a second surface, with rays or a beam of light capable of penetrating through the first and second surfaces of the optical substrate;

an optical thin film provided on the first surface or the second surface of the optical substrate;

at least one optical polarization layer formed on a surface of the optical thin film, with the ray or the beam of light capable of penetrating through the optical polarization layer; and

at least one miniature surface structure formed on the optical polarization layer to form a miniature-structure polarization grating which provides an optical polarization characteristic;

wherein a polarization effect of the ray or the beam of light is generated while penetrating through the miniature-structured polarization grating.

The method of an optical lens device having a polarization miniature structure in accordance with an aspect of the present invention includes:

providing a first surface and a second surface on an optical substrate through which rays or a beam of light to penetrate;

providing at least one optical thin film on the first surface or the second surface of the optical substrate;

providing at least one optical polarization layer on a surface of the optical thin film, with the ray or the beam of light capable of penetrating through the optical polarization layer;

utilizing a tool to physically form at least one miniature surface structure on the optical polarization layer to form a miniature-structure polarization grating which provides an optical polarization characteristic; and

generating a polarization effect of the ray or the beam of light while penetrating through the miniature-structured polarization grating of the optical thin film.

In a separate aspect of the present invention, the optical substrate is selected from a single-layer optical substrate or a multiple-complex-layer optical substrate.

In a further separate aspect of the present invention, the optical thin film is formed as a protective layer to protect the first surface or the second surface of the optical substrate.

In yet a further separate aspect of the present invention, the optical thin film is selected from a single-layer optical thin film or a multiple-complex-layer optical thin film.

In yet a further separate aspect of the present invention, the miniature surface structure is selected from a sawtooth-shaped miniature structure, a wavy-shaped miniature structure, a groove-shaped miniature structure, a concave-shaped miniature structure, a prism-shaped miniature structure, a convex-shaped miniature structure and combinations thereof.

In yet a further separate aspect of the present invention, the miniature surface structure is formed from a predetermined pattern.

In yet a further separate aspect of the present invention, the predetermined pattern is selected from a plurality of concentric rings, a plurality of railings, a plurality of letters and combinations thereof.

In yet a further separate aspect of the present invention, the optical substrate and the optical thin film are combined and treated to form as a single-layer optical substrate.

In yet a further separate aspect of the present invention, the miniature surface structure is selected from a regular-distributed miniature surface structure or an irregular-distributed miniature surface structure.

In yet a further separate aspect of the present invention, the miniature surface structure penetrates through the optical thin film to form a plurality of through-hole structures.

In yet a further separate aspect of the present invention, the miniature surface structure is protruded from the surface of the optical thin film.

In yet a further separate aspect of the present invention, the miniature surface structure is recessed in the surface of the optical thin film.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic side view of an optical lens device having a polarization miniature structure in accordance with a first preferred embodiment of the present invention.

FIG. 2 is a flow chart of a method of an optical lens device having a polarization miniature structure in accordance with a preferred embodiment of the present invention.

FIG. 3 is a schematic side view of an optical lens device having a polarization miniature structure in accordance with a second preferred embodiment of the present invention.

FIG. 4 is a schematic side view of an optical lens device having a polarization miniature structure in accordance with a third preferred embodiment of the present invention.

FIG. 5 is a schematic side view of an optical lens device having a polarization miniature structure in accordance with a fourth preferred embodiment of the present invention.

FIG. 6 is a schematic side view of an optical lens device having a polarization miniature structure in accordance with a fifth preferred embodiment of the present invention.

FIG. 7 is a schematic side view of an optical lens device having a polarization miniature structure in accordance with a sixth preferred embodiment of the present invention.

FIG. 8 is a schematic side view of an optical lens device having a polarization miniature structure in accordance with a seventh preferred embodiment of the present invention.

FIG. 9A is a schematic side view of an optical lens device having a polarization miniature structure with a first pattern of miniature surface structure in accordance with a preferred embodiment of the present invention.

FIG. 9B is a schematic side view of an optical lens device having a polarization miniature structure with a second pattern of miniature surface structure in accordance with a preferred embodiment of the present invention.

FIG. 9C is a schematic side view of an optical lens device having a polarization miniature structure with a third pattern of miniature surface structure in accordance with a preferred embodiment of the present invention.

FIG. 9D is a schematic side view of an optical lens device having a polarization miniature structure with a fourth pattern of miniature surface structure in accordance with a preferred embodiment of the present invention.

### DETAILED DESCRIPTION OF THE INVENTION

It is noted that an optical lens device having a polarization miniature structure and operation or manufacturing method thereof in accordance with the preferred embodiment of the present invention can be applicable to various glasses (including rimless glasses), various sunglasses, various smart glasses, various sport glasses (including motorcycle-riding glasses), various goggles, various 3D glasses devices, various VR wearable glasses devices, various AR wearable glasses devices or other optical devices such as sensor lens devices, camera lens devices, computer display glasses or TV screen glasses, which are not limitative of the present invention.

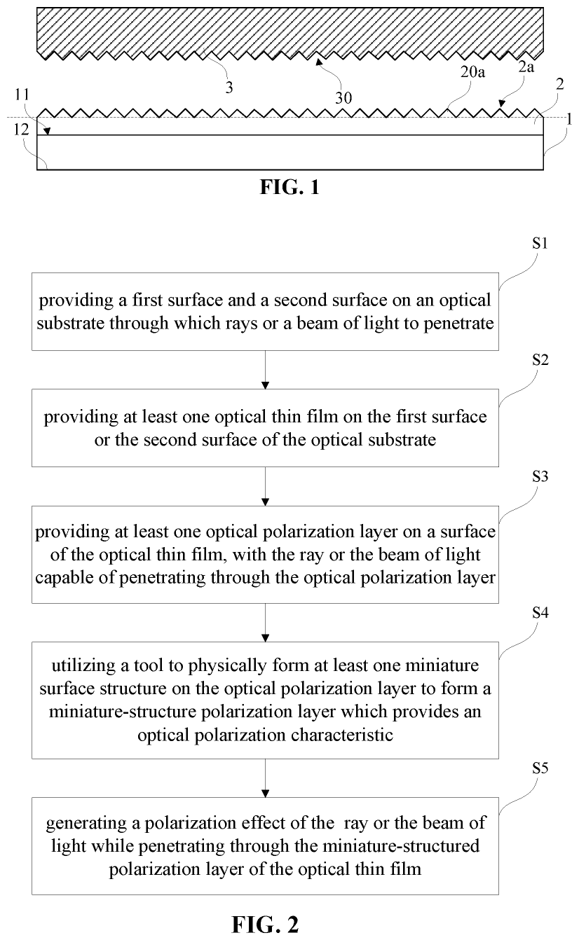

FIG. 1 shows a schematic side view of an optical lens device having a polarization miniature structure in accordance with a first preferred embodiment of the present invention. Referring now to FIG. 1, the optical lens device in accordance with the first preferred embodiment of the present invention includes an optical substrate 1, at least one optical thin film 2, at least one first optical polarization layer 2a, at least one first miniature structure 20a or at least one first microstructure.

With continued reference to FIG. 1, by way of example, the optical substrate 1 is selected from a single-layer optical substrate or a multiple-complex-layer optical substrate, with the optical substrate 1 having a uniform thickness selectively made of a glass material, a plastic material, an eco-friendly plastic material, a macromolecule material, a PC (polycarbonate) material, a PMMA (poly(methyl methacrylate)) material, a nylon material or similar materials.

Still referring to FIG. 1, by way of example, the optical substrate 1 is selected from an optical polarization layer, an anti-reflection layer, a photochromic material, anti-blue layer, anti-blue UV layer, an anti-infrared layer or other functional layer (e.g., anti-fog layer or scratch resistant layer) or combinations thereof.

Still referring to FIG. 1, by way of example, the optical thin film 2 is selected from a single-layer optical thin film or a multiple-complex-layer optical thin film which is made of materials similar or dissimilar to those of the optical substrate 1 (e.g., composition or refractive index) and the optical thin film 2 is formed as a protective layer or an equivalent layer having a protective function to protect a surface of the optical substrate 1 from damages in a mechanical or laser processing procedure or in normal use.

Still referring to FIG. 1, by way of example, the optical thin film 2 is selectively coated with an optical reflective layer, an anti-reflection layer, a splitter layer, a filtering layer or a metal thin layer, with metals selected from aluminum (Al), gold (Au), silver (Ag), nickel (Ni), chromium (Cr), alloys thereof or combinations thereof.

Still referring to FIG. 1, by way of example, the optical thin film 2 is further selectively coated with another metal oxide material to form an anti-reflection (AR) layer or a high transmittance AR coating layer, with metal oxide materials selected from hafnium oxide (HfO₂), aluminum oxide (Al₂O₃), tantalum pentoxide (Ta₂O₅), silicon dioxide (SiO₂), titanium oxide (TiO₂), zirconium dioxide (ZrO₂), magnesium fluoride (MgF₂), alloys thereof or combinations thereof.

Still referring to FIG. 1, by way of example, the first optical polarization layer 2a and the first miniature structure 20a of the optical thin film 2 have a miniature specification (e.g., miniature width, miniature depth, miniature height or other sizes) to form a miniature grating structure, thereby the first miniature structure 20a providing a function of optical polarization in the first optical polarization layer 2a.

FIG. 2 is a flow chart of a method of an optical lens device having a polarization miniature structure in accordance with a preferred embodiment of the present invention. Turning now to FIGS. 1 and 2, by way of example, the method of an optical lens device having a polarization miniature structure includes the step S1: providing a first surface (i.e., front-side surface) 11 and a second surface (i.e., rear-side surface) 12 on the first optical substrate 1 through which rays or a beam of light can be penetrated.

Still referring to FIGS. 1 and 2, by way of example, the method of an optical lens device having a polarization miniature structure includes the step S2: selectively providing at least one optical thin film 2 on the first surface (i.e., front-side surface) 11 or the second surface (i.e., rear-side surface) 12 of the optical substrate 1.

Still referring to FIGS. 1 and 2, by way of example, the method of an optical lens device having a polarization miniature structure includes the step S3: providing one or more of the first optical polarization layers 2a on a front-side surface or a rear-side surface of the optical thin film 2 in an integrated manner with similar or different refractive indexes or colors from those of the optical substrate 1, with the ray or the beam of light capable of penetrating through the first optical polarization layer 2a. The first optical polarization layer 2a is integrated into the optical substrate 1 (e.g., between front and rear surfaces) which is selected from a single-layer optical substrate or a multiple-complex-layer optical substrate.

With continued reference to FIGS. 1 and 2, by way of example, in another preferred embodiment, two first optical polarization layers 2a of two separate optical thin films 2 made of similar or dissimilar materials or refractive indexes are provided on the first surface (i.e., front-side surface) 11 and the second surface (i.e., rear-side surface) 12 of the optical substrate 1 in an integrated manner to form a double-sided optical polarization substrate, with the two first optical polarization layers 2a provide optical polarization in different angular directions of light.

Still referring to FIGS. 1 and 2, by way of example, the method of an optical lens device having a polarization miniature structure includes the step S4: utilizing a tool (e.g., extrusion molding device or other devices) to physically form the first miniature structure 20a (e.g., miniature surface structure) on the first optical polarization layer 2a of the optical thin film 2 to form a miniature-structure polarization grating (or grating barrier) which provides an optical polarization characteristic and a degree of light transmittance.

Still referring to FIGS. 1 and 2, by way of example, in forming the first optical polarization layer 2a and the first miniature structure 20a of the optical thin film 2 may selectively be processed by an extrusion molding procedure, a thermal extrusion molding procedure or other physical processing manner.

Still referring to FIGS. 1 and 2, by way of example, in a preferred embodiment, an extrusion molding device 3 with an extrusion molding surface 30, as best shown in FIG. 1, is applied to form the first optical polarization layer 2a and the first miniature structure 20a on one or both surfaces of the optical thin film 2.

Still referring to FIGS. 1 and 2, by way of example, the optical substrate 1 and the first optical polarization layer 2a (first miniature structure 20a) of the optical thin film 2 made of similar or different refractive indexes or colors of materials are formed in an integrated manner (e.g., thermal treatment) to form as a single-layer substrate to reduce a total thickness and may be made of same material.

Still referring to FIGS. 1 and 2, by way of example, the method of an optical lens device having a polarization miniature structure includes the step S5: generating a polarization effect of the ray or the beam of light on the optical thin film 2 and the optical substrate 1 while penetrating through the miniature-structured polarization grating of the first optical polarization layer 2a of the optical thin film 2.

Still referring to FIGS. 1 and 2, by way of example, the first miniature structure 20a with a profile is selected from a sawtooth-shaped miniature structure or the like, with the first miniature structure 20a selected from a regular-distributed miniature surface structure or an irregular-distributed miniature surface structure, with the first miniature structure 20a protruded from the surface of the optical thin film 2, as best shown in dotted line in FIG. 1.

FIG. 3 is a schematic side view of an optical lens device having a polarization miniature structure in accordance with a second preferred embodiment of the present invention. Turning now to FIG. 3, in comparison with the first embodiment, the optical lens device in accordance with the second preferred embodiment has the first miniature structure 20a recessed in the surface (e.g., front-side surface or rear-side surface) of the optical thin film 2, as best shown in dotted line in FIG. 3, provided on the first surface 11 or the second surface 12 of the optical substrate 1.

FIG. 4 is a schematic side view of an optical lens device having a polarization miniature structure in accordance with a third preferred embodiment of the present invention. Turning now to FIG. 4, in comparison with the first embodiment, the optical lens device in accordance with the third preferred embodiment is formed with a curved optical substrate 1a which has at least one curved surface on which to provide the optical thin film 2, as best shown in dotted line in FIG. 4.

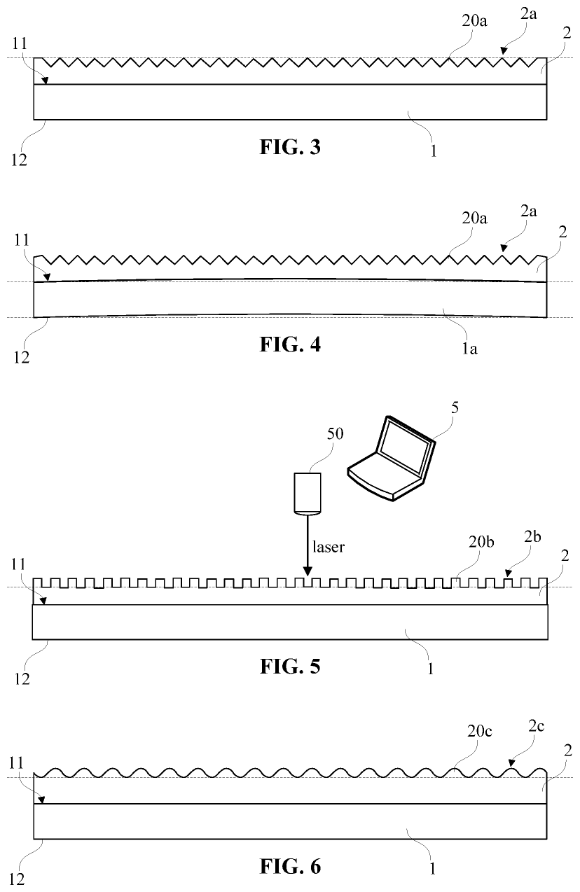

FIG. 5 is a schematic side view of an optical lens device having a polarization miniature structure in accordance with a fourth preferred embodiment of the present invention. Turning now to FIG. 5, in comparison with the first embodiment, the optical lens device in accordance with the fourth preferred embodiment includes the surface of the optical thin film 2 processed by a laser beam to form a second miniature structure 20b which forms a second optical polarization layer 2b.

Still referring to FIG. 5, by way of example, a laser machine with a laser emitter 50, as best shown in top portion in FIG. 5, is selected to process the second optical polarization layer 2b, with a laser beam or multiple laser beams emitted from the laser emitter 50 to form the second miniature structure 20b of the second optical polarization layer 2b of the optical thin film 2 provided on the optical substrate 1.

Still referring to FIG. 5, by way of example, the laser machine further includes a control unit 5 of the laser machine or other equivalent devices having a laser-control function to control the laser beam emitted from the laser emitter 50 which further includes a filter member or other elements. The laser machine can be selected from a desktop laser machining device, a multi-axis laser machining device or other laser machining devices.

Still referring to FIG. 5, by way of example, the laser beam applied in the present invention has a predetermined laser type, a predetermined wavelength and a predetermined power which can be selected according to various needs. The laser beam further has a predetermined radius or diameter or a dot shape (i.e., circle, ellipse or other suitable shapes).

Still referring to FIG. 5, by way of example, in a preferred embodiment, the optical thin film 2 is initially extruded or thermal-extruded to form a semi-processed miniature structure which is further processed to form a fully-processed miniature structure by a laser beam or other different manners so as to provide a complex miniature structure.

FIG. 6 is a schematic side view of an optical lens device having a polarization miniature structure in accordance with a fifth preferred embodiment of the present invention. Turning now to FIG. 6, in comparison with the first embodiment, the optical lens device in accordance with the fifth preferred embodiment includes the optical thin film 2 formed with a third optical polarization layer 2c and a third miniature structure 20c which has a profile of wavy to form a wavy-shaped miniature structure.

FIG. 7 is a schematic side view of an optical lens device having a polarization miniature structure in accordance with a sixth preferred embodiment of the present invention. Turning now to FIG. 7, in comparison with the first embodiment, the optical lens device in accordance with the sixth preferred embodiment includes the optical thin film 2 formed with a fourth optical polarization layer 2d and a fourth miniature structure 20d which penetrates through the optical thin film 2 to form a plurality of through-hole structures. Additionally, the fourth miniature structure 20d has a profile to form a groove-shaped miniature structure, a concave-shaped miniature structure, a prism-shaped miniature structure, a convex-shaped miniature structure and combinations thereof.

FIG. 8 is a schematic side view of an optical lens device having a polarization miniature structure in accordance with a seventh preferred embodiment of the present invention. Turning now to FIG. 8, in comparison with the first embodiment, the optical lens device in accordance with the seventh preferred embodiment includes the optical thin film 2 formed with a fifth optical polarization layer 2e and a fifth miniature structure 20e which has a profile to form a groove-shaped miniature structure. The fifth miniature structure 20d can be also selected from a concave-shaped miniature structure, a prism-shaped miniature structure, a convex-shaped miniature structure and combinations thereof.

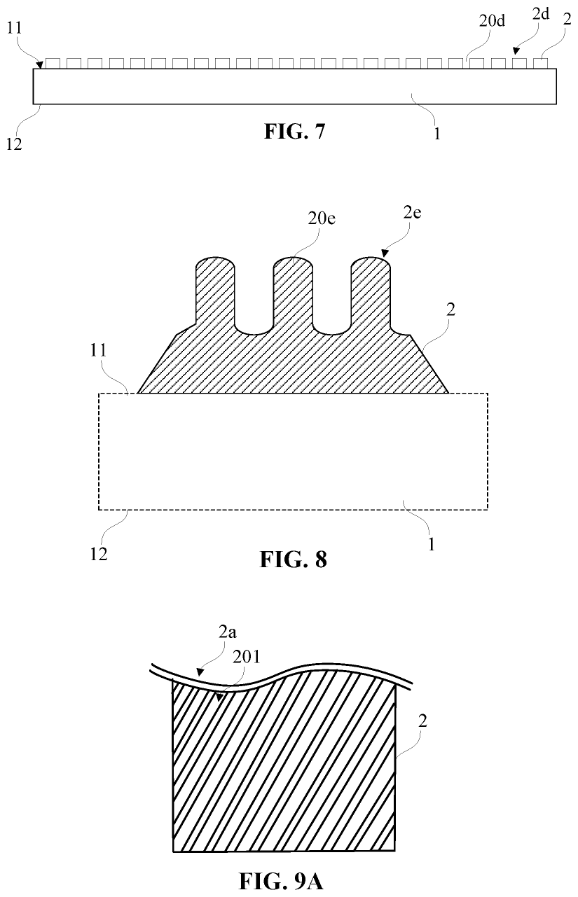

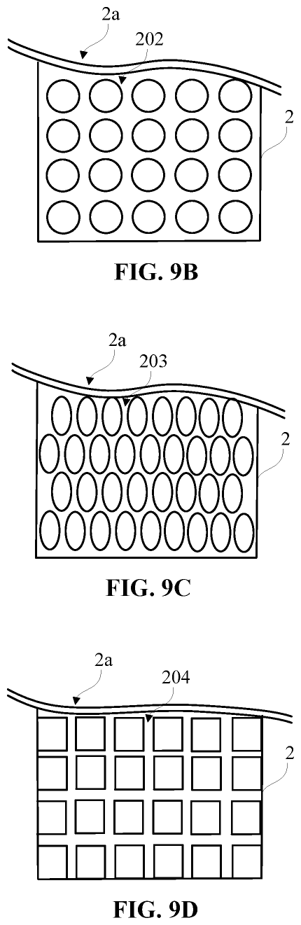

FIG. 9A is a schematic side view of an optical lens device having a polarization miniature structure with a first pattern of miniature surface structure in accordance with a preferred embodiment of the present invention. Turning now to FIG. 9A, by way of example, the optical thin film 2 selectively has a predetermined pattern to form an optical polarization layer 2, with the predetermined pattern formed from a first miniature structure pattern 201 which is an inclined-groove pattern.

FIG. 9B is a schematic side view of an optical lens device having a polarization miniature structure with a second pattern of miniature surface structure in accordance with a preferred embodiment of the present invention. Turning now to FIG. 9B, by way of example, the optical thin film 2 selectively has a predetermined pattern to form an optical polarization layer 2, with the predetermined pattern formed from a second miniature structure pattern 202 which is a circle-array pattern.

FIG. 9C is a schematic side view of an optical lens device having a polarization miniature structure with a third pattern of miniature surface structure in accordance with a preferred embodiment of the present invention. Turning now to FIG. 9C, by way of example, the optical thin film 2 selectively has a predetermined pattern to form an optical polarization layer 2, with the predetermined pattern formed from a third miniature structure pattern 203 which is an ellipse-array pattern.

FIG. 9D is a schematic side view of an optical lens device having a polarization miniature structure with a fourth pattern of miniature surface structure in accordance with a preferred embodiment of the present invention. Turning now to FIG. 9D, by way of example, the optical thin film 2 selectively has a predetermined pattern to form an optical polarization layer 2, with the predetermined pattern formed from a fourth miniature structure pattern 204 which is a square-array pattern.

Referring back to FIGS. 9A to 9D, by way of example, in another embodiment, patterns of the optical thin film 2 is selected from a plurality of concentric rings, a plurality of railings, a plurality of letters and combinations thereof.

Although the invention has been described in detail with reference to its presently preferred embodiment, it will be understood by one of ordinary skills in the art that various modifications can be made without departing from the spirit and the scope of the invention, as set forth in the appended claims.

What is claimed is:

1. An optical lens device comprising:
an optical substrate having a first surface and a second surface, with rays or a beam of light capable of penetrating through the first and second surfaces of the optical substrate;
at least one optical thin film provided on the first surface or the second surface of the optical substrate;
at least one optical polarization layer provided on a predetermined surface of the optical thin film, with the ray or the beam of light capable of penetrating through the optical polarization layer; and
at least one miniature surface structure formed on the optical polarization layer to form a miniature-structure polarization grating which provides an optical polarization characteristic;
wherein a polarization effect of the ray or the beam of light is generated while penetrating through the miniature-structured polarization grating.

2. The optical lens device as defined in claim 1, wherein the optical thin film is selected from a single-layer optical thin film or a multiple-complex-layer optical substrate.

3. The optical lens device as defined in claim 1, wherein the miniature surface structure is selected from a sawtooth-shaped miniature structure, a wavy-shaped miniature structure, a groove-shaped miniature structure, a concave-shaped miniature structure, a prism-shaped miniature structure, a convex-shaped miniature structure and combinations thereof.

4. The optical lens device as defined in claim 1, wherein the miniature surface structure is formed from a predetermined pattern.

5. The optical lens device as defined in claim 4, wherein the predetermined pattern is selected from a plurality of concentric rings, a plurality of railings, a plurality of letters and combinations thereof.

6. The optical lens device as defined in claim 1, wherein the optical substrate and the optical thin film are combined and treated to form as a single-layer optical substrate.

7. The optical lens device as defined in claim 1, wherein the miniature surface structure is selected from a regular-distributed miniature surface structure or an irregular-distributed miniature surface structure which is protruded from or recessed in the predetermined surface of the optical thin film.

8. The optical lens device as defined in claim 1, wherein the optical thin film is formed as a protective layer to protect the first surface or the second surface of the optical substrate.

9. The optical lens device as defined in claim 1, wherein the miniature surface structure penetrates through the optical thin film to form a plurality of through-hole structures.

10. The optical lens device as defined in claim 1, wherein another optical polarization layer of a separate optical thin film further provided on the second surface of the optical substrate to form a double-sided optical polarization substrate.

11. A method for an optical lens device comprising:
providing a first surface and a second surface on an optical substrate through which rays or a beam of light to penetrate;
providing at least one optical thin film on the first surface or the second surface of the optical substrate;
providing at least one optical polarization layer on a predetermined surface of the optical substrate, with the ray or the beam of light capable of penetrating through the optical polarization layer;
utilizing a tool to physically form at least one miniature surface structure on the optical polarization layer to form a miniature-structure polarization grating which provides an optical polarization characteristic; and
generating a polarization effect of the ray or the beam of light while penetrating through the miniature-structured polarization grating of the optical thin film.

12. The method for the optical lens device as defined in claim 11, wherein the optical thin film is selected from a single-layer optical thin film or a multiple-complex-layer optical thin film.

13. The method for the optical lens device as defined in claim 11, wherein the miniature surface structure is selected from a sawtooth-shaped miniature structure, a wavy-shaped miniature structure, a groove-shaped miniature structure, a concave-shaped miniature structure, a prism-shaped miniature structure, a convex-shaped miniature structure and combinations thereof.

14. The method for the optical lens device as defined in claim 11, wherein the miniature surface structure is formed from a predetermined pattern.

15. The method for the optical lens device as defined in claim 14, wherein the predetermined pattern is selected from a plurality of concentric rings, a plurality of railings, a plurality of letters and combinations thereof.

16. The method for the optical lens device as defined in claim 11, wherein the optical substrate and the optical thin film are combined and treated to form as a single-layer optical substrate.

17. The method for the optical lens device as defined in claim 11, wherein the miniature surface structure is selected from a regular-distributed miniature surface structure or an irregular-distributed miniature surface structure which is protruded from or recessed in the predetermined surface of the optical thin film.

18. The method for the optical lens device as defined in claim 11, wherein the optical thin film is formed as a protective layer to protect the first surface or the second surface of the optical substrate.

19. The method for the optical lens device as defined in claim 11, wherein the miniature surface structure penetrates through the optical thin film to form a plurality of through-hole structures.

20. The method for the optical lens device as defined in claim 11, wherein another optical polarization layer of a separate optical thin film further provided on the second surface of the optical substrate to form a double-sided optical polarization substrate.
